(19) United States
(12) Patent Application Publication
(10) Pub. No.: US 2024/0414786 A1
(43) Pub. Date: Dec. 12, 2024

(54) COMMUNICATION SETTING METHOD

(71) Applicant: Lenovo (Singapore) Pte. Ltd., Singapore (SG)

(72) Inventors: Yosuke Katayama, Kanagawa (JP); Kazunobu Umeda, Kanagawa (JP)

(73) Assignee: Lenovo (Singapore) Pte. Ltd., Singapore (SG)

(21) Appl. No.: 18/676,942

(22) Filed: May 29, 2024

(30) Foreign Application Priority Data
Jun. 9, 2023 (JP) 2023-095764

(51) Int. Cl. H04W 76/14

(52) U.S. Cl. CPC H04W 76/14

(57) ABSTRACT

A communication setting method of enabling a first communication device and a second communication device that are shipped together as a set and are compliant with common wireless communication to be connected to each other by the wireless communication includes a step in which a storage controller in the first communication device causes a storage in the first communication device to store, at a predetermined stage before the shipping, communication connection information that is issued for the first communication device and includes predetermined identification information used for the connection; and a step in which a storage controller in the second communication device causes a storage in the second communication device to store, at a predetermined stage before the shipping, the same communication connection information as stored in the storage in the first communication device.

### CROSS-REFERENCE TO RELATED APPLICATIONS

This application claims priority to Japanese Patent Application No. 2023-095764 filed on Jun. 9, 2023, the contents of which are hereby incorporated herein by reference in their entirety.

### BACKGROUND OF THE INVENTION

### Field of the Invention

The present invention relates to a communication setting method.

### Description of the Related Art

A technology of pairing two wireless devices by Bluetooth Low Energy (registered trademark) or the like is known.

### CITATION LIST

### Patent Document

### [Patent Document 1]

Japanese Unexamined Patent Application Publication No. 2020-205614

For example, an information processing device such as a personal computer and a peripheral device such as a keyboard may be packed together and delivered to an end user. In this case, if the information processing device and the peripheral device are already paired and connected when the end user takes the information processing device and the peripheral device out of the box and starts them up, the end user can immediately use the information processing device to which the peripheral device is connected with no need to perform the pairing operation.

One or more embodiments ensure that an information processing device and a peripheral device are already paired when an end user to whom the information processing device and the peripheral device have been delivered starts using the information processing device and the peripheral device.
(1) An aspect of the present invention is a communication setting method of enabling a first communication device and a second communication device that are shipped together as a set and are compliant with common wireless communication to be connected to each other by the wireless communication, the communication setting method including: a step in which a storage control unit in the first communication device causes a storage unit in the first communication device to store, at a predetermined stage before the shipping, communication connection information that is issued for the first communication device and includes predetermined identification information used for the connection; and a step in which a storage control unit in the second communication device causes a storage unit in the second communication device to store, at a predetermined stage before the shipping, the same communication connection information as stored in the storage unit in the first communication device.

### SUMMARY OF THE INVENTION

(2) The aspect of the present invention may be the communication setting method according to (1), further including a step in which a communication connection information issuance unit in the first communication device generates the communication connection information.
(3) The aspect of the present invention may be the communication setting method according to (1) or (2), wherein the storage unit in the first communication device is non-volatile memory.
(4) The aspect of the present invention may be the communication setting method according to any one of (1) to (3), further including a step in which, after the shipping, a communication unit in the first communication device executes advertising for pairing with the second communication device within an allowable range of a number of startups.
(5) The aspect of the present invention may be the communication setting method according to any one of (1) to (4), wherein the second communication device is an information processing device, and the first communication device is a peripheral device of the information processing device.

The above-described aspect of the present invention has the effect of ensuring that an information processing device and a peripheral device are already paired when an end user to whom the information processing device and the peripheral device have been delivered starts using the information processing device and the peripheral device.

### BRIEF DESCRIPTION OF THE DRAWINGS

FIG. 1 is a diagram illustrating an example of the appearance of an information processing system in one or more embodiments.

FIG. 2 is a diagram illustrating an example of the functional structure of an information processing device in one or more embodiments.

FIG. 3 is a diagram illustrating an example of the functional structure of a keyboard in one or more embodiments.

FIG. 4 is a sequence diagram illustrating an example of a procedure executed in relation to pairing between the information processing device and the keyboard in one or more embodiments.

### DETAILED DESCRIPTION OF THE INVENTION

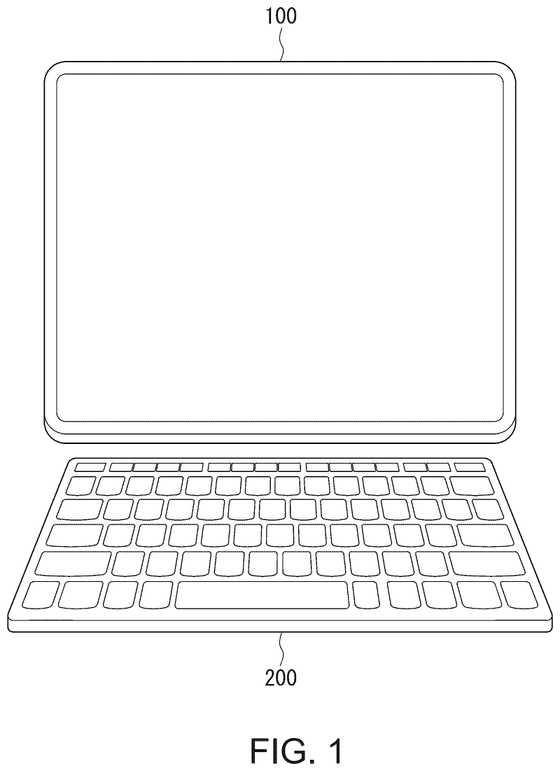

FIG. 1 illustrates an example of the appearance of an information processing system in one or more embodiments. The information processing system in one or more embodiments includes an information processing device 100 (an example of a second communication device) and a keyboard 200 (an example of a first communication device).

The information processing device 100 performs information processing in response to operations by an end user. The information processing device 100 includes a touch panel that is a combination of a display device and a touch sensor. The end user can use the information processing device 100 by operating the touch panel.

The keyboard 200 has an arrangement of various keys to which letters, numbers, symbols, and functions are assigned. The keyboard 200 is an input device used by the end user to perform operations such as character input.

The information processing device 100 and the keyboard 200 are connected so as to be capable of communicating with each other by short-range wireless communication. The short-range wireless communication scheme with which the information processing device 100 and the keyboard 200 are compliant may be, for example, Bluetooth Low Energy (registered trademark).

In a state in which the information processing device 100 and the keyboard 200 are connected by short-range wireless communication, the keyboard 200 transmits operation signals corresponding to operations performed on the keys to the information processing device 100. The information processing device 100 executes processes, such as character input, corresponding to the received operation signals.

In one or more embodiments, the information processing device 100 and the keyboard 200 are packed together as a set and delivered to the end user.

Moreover, in one or more embodiments, the information processing device 100 and the keyboard 200 are already paired and connected so as to be capable of communicating with each other when the end user unpacks the information processing device 100 and the keyboard 200 from the box and starts up the information processing device 100 and the keyboard 200 for the first time. Thus, the end user does not need to perform the operation of pairing the information processing device 100 and the keyboard 200 when starting up the information processing device 100 and the keyboard 200 for the first time to use them.

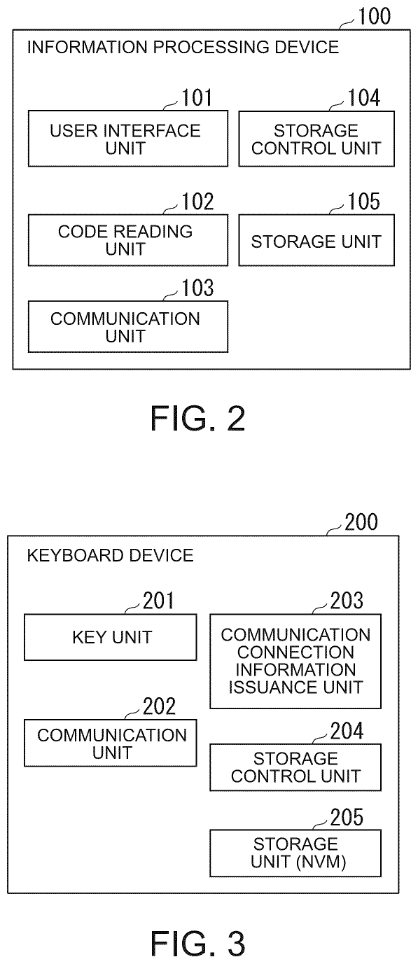

FIG. 2 illustrates an example of the functional structure of the information processing device 100 mainly related to connection by short-range wireless communication. The functions of the information processing device 100 in FIG. 2 are achieved by a central processing unit (CPU) included in the hardware of the information processing device 100 executing a program.

The information processing device 100 in FIG. 2 includes a user interface unit 101 (user interface), a code reading unit 102 (code reader), a communication unit 103 (communicator), a storage control unit 104 (storage controller), and a storage unit 105 (storage).

The user interface unit 101 includes input devices and output devices included in the information processing device 100. In the case of the information processing device 100 in one or more embodiments, the user interface unit 101 may include the touch panel.

The code reading unit 102 executes code reading. In detail, the code reading unit 102 includes a code scanner, and extracts information from code symbols read by the code scanner. The code symbols may be, for example, one-dimensional codes (barcodes) or two-dimensional codes.

The communication unit 103 connects to an external device so as to be capable of communication by short-range wireless communication.

The storage control unit 104 causes the storage unit 105 to store information.

The storage unit 105 stores various information related to the information processing device 100.

FIG. 3 illustrates an example of the functional structure of the keyboard 200 mainly related to connection by short-range wireless communication. The functions of the keyboard 200 in FIG. 3 are achieved by a central processing unit (CPU) included in the hardware of the keyboard 200 executing a program.

The keyboard 200 in FIG. 3 includes a key unit 201 (key), a communication unit 202 (communicator), a communication connection information issuance unit 203 (communication connection information issuance), a storage control unit 204 (storage controller), and a storage unit 205 (storage).

The key unit 201 outputs operation signals corresponding to operations performed on the keys arranged on the keyboard 200.

The communication unit 202 connects to an external device so as to be capable of communication by short-range wireless communication.

The communication connection information issuance unit 203 issues communication connection information. The communication connection information is information used when the communication device as the keyboard 200 sets up a connection (pairing) with another communication device, and includes a device ID uniquely indicating the communication device as the keyboard 200 and an authentication code for authenticating the communication device as the keyboard 200. The authentication code may be, for example, a PIN code.

For example, the communication connection information issuance unit 203 may issue the device ID and the authentication code using random values obtained by generating random numbers.

The communication connection information issuance unit 203 may be included in the external device connected to the keyboard 200, for example.

The storage control unit 204 causes the storage unit 205 to store the communication connection information issued by the communication connection information issuance unit 203.

The storage unit 205 stores the communication connection information issued by the communication connection information issuance unit 203. The storage unit 205 in which the communication connection information is stored may be non-volatile memory (NVM) that stores written data in a non-rewritable state. The storage area in which the communication connection information is stored in the storage unit 205 may be an area inaccessible by the end user.

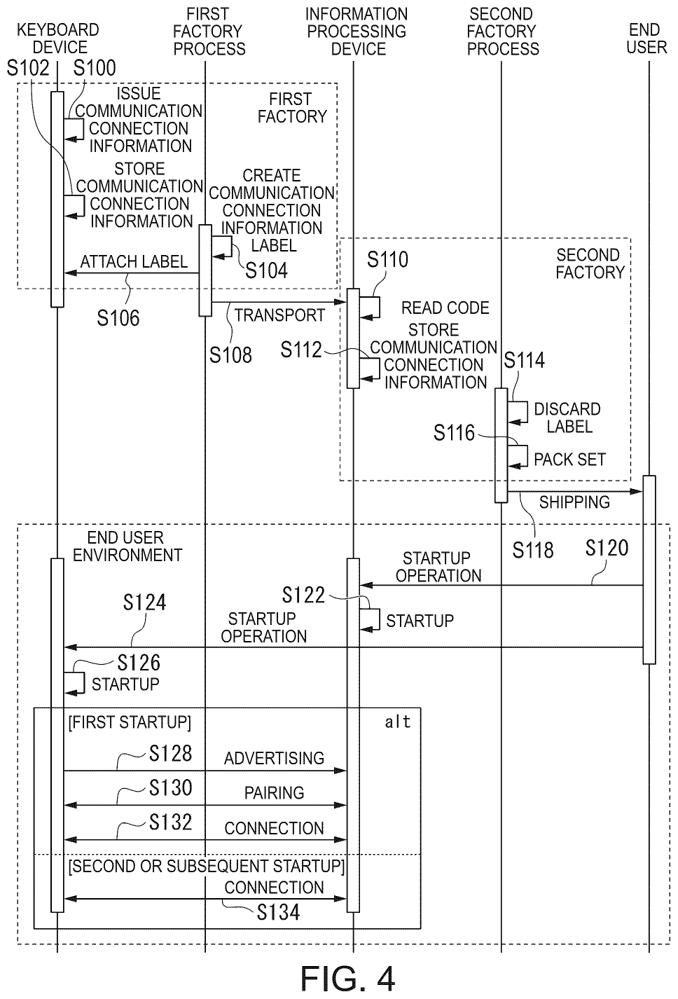

An example of a procedure executed in relation to pairing between the information processing device 100 and the keyboard 200 in one or more embodiments will be described with reference to the sequence diagram in FIG. 4.

In the following description, a distribution form in which the keyboard 200 manufactured at a first factory is transported to a second factory where the information processing device 100 is manufactured and the information processing device 100 and the keyboard 200 are packed together in the same box at the second factory and delivered to the end user is used as an example.

Step S100: At the first factory, the communication connection information issuance unit 203 in the manufactured keyboard 200 issues communication connection information corresponding to the keyboard 200. The communication connection information includes a device ID uniquely indicating the communication device as the keyboard 200 and an authentication code corresponding to the keyboard 200.

Step S102: The storage control unit 204 causes the storage unit 205 to store the communication connection information issued in step S100.

Step S104: At the first factory, a label is created by printing, on label paper, a code symbol (for example, a two-dimensional code) indicating the communication connection information issued by the communication connection information issuance unit 203 in step S100.

Step S106: At the first factory, the label created in step S104 is attached to the packing material in which the corresponding keyboard 200 is packed. Attaching the label to the packing material at the first factory may be performed by a device such as a robot or performed manually by a worker.

Step S108: The keyboard 200 packed in the packing material to which the label is attached in step S106 is transported to the second factory.

Step S110: At the second factory, the code reading unit 102 in the information processing device 100 reads the code symbol printed on the label attached to the packing material of the keyboard 200 transported. Reading the code symbol may be performed, for example, as an operation by a worker at the second factory.

Step S112: In response to the reading of the code symbol in step S110, the code reading unit 102 acquires the communication connection information from the read code symbol. The storage control unit 104 then causes the storage unit 105 to store the acquired communication connection information.

Step S114: At the second factory, the label from which the code symbol has been read is peeled off from the packing material and discarded.

Step S116: At the second factory, the keyboard 200 whose corresponding code symbol has been read and the information processing device 100 in which the communication connection information of the read code symbol has been stored are packed together in one cardboard box or the like as a set.

Step S118: The box in which the keyboard 200 and the information processing device 100 are packed in step S116 is shipped and delivered to the end user by home delivery, in-store pickup, or the like.

Step S120: The end user takes the information processing device 100 and the keyboard 200 out of the box in an environment (end user environment) in which the information processing device 100 and the keyboard 200 are used. To connect and use the information processing device 100 and the keyboard 200, the end user first performs an operation (startup operation) of starting up the information processing device 100 in a state in which the information processing device 100 and the keyboard 200 are within the communication range of the communication unit 103 and the communication unit 202.

Step S122: The information processing device 100 starts up in response to the startup operation in step S120.

Step S124: Following the startup operation in step S120, the end user performs a startup operation on the keyboard 200.

Step S126: The keyboard 200 starts up in response to the startup operation in step S124.

Step S128: The communication unit 202 in the keyboard 200 determines whether the current startup in step S126 is the first startup after the shipping or the second or subsequent startup after the shipping. In the case where the communication unit 202 determines that the current startup is the first startup, the communication unit 202 executes advertising for pairing.

Step S130: In response to the advertising executed in step S128, the communication unit 202 in the keyboard 200 and the communication unit 103 in the information processing device 100 existing within the communication range of the communication unit 202 perform pairing in short-range wireless communication. During the pairing, the keyboard 200 and the information processing device 100 exchange the respective communication connection information, and store the exchanged communication connection information. Through such pairing, the keyboard 200 and the information processing device 100 are set to be communication partners in short-range wireless communication.

Step S132: The communication unit 202 in the keyboard 200 and the communication unit 103 in the information processing device 100 paired in step S130 establish a connection so as to be capable of communicating with each other, each using the communication connection information of the communication partner stored as a result of the pairing.

Step S134: In the case where the communication unit 202 determines that the current startup in step S126 is the second or subsequent startup, the communication unit 202 establishes a connection so as to be capable of communicating with the communication unit 103 in the information processing device 100 using the connection setting information of the communication partner stored as a result of the pairing in step S130 in the first startup.

With the above-described structure, when the end user takes out the information processing device 100 and the keyboard 200 packed together in the box and uses them, starting up the information processing device 100 and the keyboard 200 can produce a state in which the information processing device 100 and the keyboard 200 are already connected via short-range wireless communication. Therefore, after starting up the information processing device 100 and the keyboard 200, the end user can immediately operate the keyboard 200 to use the information processing device 100 with no need to perform any pairing operation.

In the procedure in FIG. 4, the communication connection information of the keyboard 200 is issued by the keyboard 200 using random numbers or the like at the first factory where the keyboard 200 is manufactured. This enhances the confidentiality of the communication connection information as compared with, for example, the case where a list of communication connection information is prepared in advance and communication connection information is written sequentially to manufactured keyboards 200.

Moreover, as a result of the hardware that corresponds to the storage unit 205 in which the communication connection information is stored in the keyboard 200 being non-volatile memory inaccessible by the end user, external reading and tampering can be prevented.

In addition, since writing (storing) the communication connection information of the keyboard 200 to the information processing device 100 at the second factory is performed not by inputting a specific character string or the like but by reading a code symbol, the confidentiality of the communication connection information can be maintained.

Furthermore, advertising executed by the keyboard 200 for pairing is limited to the first startup and is not executed from the second startup onward. This limits the number of times the communication connection information is transmitted and received between the keyboard 200 and the information processing device 100 to one time, so that the possibility of eavesdropping of the communication connection information can be reduced. Alternatively, the number of times the keyboard 200 is allowed to execute advertising may be set within a predetermined range of the number of startups, such as from the first startup to the third startup.

Thus, in one or more embodiments, in the case where the keyboard 200 is included in a set with the information processing device 100 and delivered to the end user, the possibility of leakage of the communication connection information of the keyboard 200 can be effectively eliminated to enhance security against attacks by malicious users and the like.

The first communication device connected to the information processing device 100 (the second communication device) by short-range wireless communication is not limited to the keyboard 200. Examples of the first communication device include an external storage device, a disk drive, a pen tablet, and a mouse.

The processes by the foregoing information processing device 100, keyboard 200, etc. may be performed by recoding a program for implementing the functions of the foregoing information processing device 100, keyboard 200, etc. on a computer-readable recording medium and causing a computer system to read and execute the program recorded on the recording medium. Herein, the expression “causing a computer system to read and execute the program recorded on the recording medium” includes installing the program in the computer system. The term “computer system” herein includes an OS and hardware such as peripheral devices. The “computer system” may include a plurality of computer devices connected via a network such as the Internet, a WAN, a LAN, or a communication line such as a dedicated line. The “computer-readable recording medium” refers to a portable medium such as a flexible disk, a magneto-optical disc, a ROM, or a CD-ROM, or a storage device such as a hard disk or a solid state drive embedded in the computer system. Thus, the recording medium storing the program may be a non-transitory recording medium such as a CD-ROM. The recording medium includes a recording medium internally or externally provided so as to be accessible from a distribution server for distributing the program. The code of the program stored in the recording medium of the distribution server may be different from the code of the program in a format executable on a terminal device. That is, the format in which the program is stored in the distribution server is not limited as long as it can be downloaded from the distribution server and installed in a form executable on the terminal device. A configuration in which the program is divided into a plurality of parts and the terminal device combines the parts after the parts are downloaded at different timings may be adopted, and distribution servers for distributing the parts into which the program is divided may be different. The “computer-readable recording medium” includes a medium that holds the program for a certain period of time, such as volatile memory (RAM) inside a computer system serving as a server or a client when the program is transmitted via a network. The program may be a program for implementing part of the foregoing functions. The program may be a differential file (differential program) that can implement the foregoing functions in combination with a program already recorded in the computer system.

### DESCRIPTION OF SYMBOLS

100 information processing device
101 user interface unit
102 code reading unit
103 communication unit
104 storage control unit
105 storage unit
200 keyboard
201 key unit
202 communication unit
203 communication connection information issuance unit
204 storage control unit
205 storage unit

What is claimed is:

1. A communication setting method of enabling a first communication device and a second communication device that are shipped together as a set and are compliant with common wireless communication to be connected to each other by wireless communication, the communication setting method comprising:
a step in which a storage controller in the first communication device causes a storage in the first communication device to store, at a predetermined stage before the shipping, communication connection information that is issued for the first communication device and includes predetermined identification information used for the connection; and
a step in which a storage controller in the second communication device causes a storage in the second communication device to store, at a predetermined stage before the shipping, a same communication connection information as stored in the storage in the first communication device.

2. The communication setting method according to claim 1, further comprising
a step in which a communication connection information issuance in the first communication device generates the communication connection information.

3. The communication setting method according to claim 1, wherein the storage in the first communication device is non-volatile memory.

4. The communication setting method according to claim 1, further comprising
a step in which, after the shipping, a communicator in the first communication device executes advertising for pairing with the second communication device within an allowable range of a number of startups.

5. The communication setting method according to claim 1, wherein the second communication device is an information processing device, and the first communication device is a peripheral device of the information processing device.
